(19) United States
(12) Patent Application Publication
(10) Pub. No.: US 2026/0027645 A1
(43) Pub. Date: Jan. 29, 2026

(54) Method for optimizing process parameters of friction stir welding with synchronous rolling and related device

(71) Applicant: Nanchang Hangkong University, Nanchang City (CN)

(72) Inventors: Yuhua Chen, Nanchang City (CN); Yuehua Gao, Nanchang City (CN); Qipeng Liu, Nanchang City (CN); Shanlin Wang, Nanchang City (CN)

(21) Appl. No.: 19/257,983

(22) Filed: Jul. 2, 2025

(30) Foreign Application Priority Data
Jul. 4, 2024 (CN) 202410888602.9

(51) Int. Cl. B23K 20/12

(52) U.S. Cl. CPC B23K 20/123

(57) ABSTRACT

A method for optimizing process parameters of friction stir welding with synchronous rolling and a related device are provided. A heat source model is applied to a system finite element model, and heat transfer simulation is performed on the welding and cooling processes of friction stir welding. Furthermore, contact relationships and mechanical action relationships between a stirring tool finite element model and a weldment finite element model and between a roller finite element model and the weldment finite element model are applied in the system finite element model. Thermal-mechanical simulation is performed on the welding process, the cooling process and a clamp release process of friction stir welding with synchronous rolling with a temperature field result obtained from heat transfer simulation as an input. Based on the welding stress and welding deformation results obtained from thermal-mechanical simulation, process parameters are adjusted and re-simulated until optimal parameters are obtained.

### CROSS-REFERENCE TO RELATED APPLICATION

This application claims the benefit and priority of Chinese Patent Application No. 202410888602.9 filed with the China National Intellectual Property Administration on Jul. 4, 2024, the disclosure of which is incorporated by reference herein in its entirety as part of the present disclosure.

### TECHNICAL FIELD

The present disclosure relates to the technical field of simulation optimization, and in particular to a method for optimizing process parameters of friction stir welding with synchronous rolling and a related device.

### BACKGROUND

Friction Stir Welding (FSW) is a solid-state joining method. Compared with fusion welding, the residual stress and the deformation of friction stir welding are smaller. Although the friction stir welding technology has the characteristics of small deformation, considerable welding deformation still remains non-negligible after welding for large-size thin-walled weldments or special-shaped weldments with thin-walled structures. How to effectively reduce the welding deformation of friction stir welding is still an important issue to be solved urgently in thin-plate welding.

Compared with passive post-welding straightening, the welding accompanied by straightening method is a more effective active control method. Critical parts have strict requirements on dimensional accuracy, so that it is very important to accurately control the welding deformation and the welding stress. For real weldments with complex structures, it is very time-consuming and costly to repeatedly debug only relying on experiences and empirical formulas. For example, synchronous rolling control during welding is a welding accompanied by straightening method that can reduce welding deformation, but it is very time-consuming and costly to obtain the optimal process parameters of synchronous rolling during welding through experiments. With the development of the computer technology and the numerical calculation method, it is an effective way to implement the process control by effective simulation prediction and process optimization through the computer simulation technology.

However, the existing residual stress and deformation control technologies are all aimed at fusion welding. That is, synchronous rolling during welding is used to perform a welding accompanied by straightening control. Moreover, the current welding accompanied by straightening simulation methods are all aimed at traditional fusion welding. There is no report on a welding accompanied by straightening method for friction stir welding. That is, there is no technology of using synchronous rolling during welding to perform welding accompanied by straightening control. There is no report on the simulation modeling and process optimization method of this technology.

### SUMMARY

An objective of the present disclosure is to provide a method for optimizing process parameters of friction stir welding with synchronous rolling and a related device. Optimal process parameters in which synchronous rolling during welding is used to perform a welding accompanied by straightening control on friction stir welding can be determined, which can effectively reduce welding deformation of friction stir welding.

In order to achieve the above objective, the present disclosure provides the following solution.

In a first aspect, the present disclosure provides a method for optimizing process parameters of friction stir welding with synchronous rolling, where the method for optimizing process parameters of friction stir welding with synchronous rolling includes:
establishing a system finite element model of the friction stir welding with synchronous rolling; wherein the system finite element model comprises a roller finite element model, a stirring tool finite element model and a weldment finite element model, the roller finite element model and the stirring tool finite element model are arranged perpendicularly to the weldment finite element model, the roller finite element model and the stirring tool finite element model are in contact with an upper surface of a welding seam position of the weldment finite element model, and the roller finite element model and the stirring tool finite element model are arranged at intervals;
applying a heat source model to the system finite element model to obtain a system finite element model comprising the heat source model; wherein the heat source model is a model equivalent to friction heat generation of a real stirring tool;
performing a heat transfer simulation on a welding process and a cooling process of friction stir welding by using the system finite element model comprising the heat source model to obtain a temperature field result of a real weldment; wherein the temperature field result comprises a temperature field of the real weldment at each moment in the welding process and the cooling process;
applying a contact relationship and a mechanical action relationship between the stirring tool finite element model and the weldment finite element model and applying a contact relationship and a mechanical action relationship between the roller finite element model and the weldment finite element model in the system finite element model to obtain a system finite element model comprising contact relationships and mechanical action relationships; wherein the contact relationship between the stirring tool finite element model and the weldment finite element model is a frictionless surface-to-surface contact relationship, the mechanical action relationship between the stirring tool finite element model and the weldment finite element model is to apply a vertical mechanical action force to the stirring tool finite element model, the contact relationship between the roller finite element model and the weldment finite element model is a frictional surface-to-surface contact relationship, and the mechanical action relationship between the roller finite element model and the weldment finite element model is to apply a vertical mechanical action force to the roller finite element model;
performing a thermal-mechanical simulation on the welding process, the cooling process and a clamp release process of the friction stir welding with synchronous rolling by using the system finite element model comprising the contact relationships and the mechanical action relationships, the temperature field result as an input, so as to obtain a welding stress result and a welding deformation result of the real weldment; wherein the welding stress result comprises a welding stress field of the real weldment at each moment in the welding process, the cooling process and the clamp release process; and the welding deformation result comprises a welding deformation field of the real weldment at each moment in the welding process, the cooling process and the clamp release process; and
determining whether an iteration termination condition is met; in response to a determination that the iteration termination condition is met, deeming process parameters used in a current iteration as optimized process parameters; in response to a determination that the iteration termination condition is not met, adjusting the process parameters used in the current iteration based on the welding stress result and the welding deformation result, and determining the system finite element model in a next iteration and the contact relationship and the mechanical action relationship between the roller finite element model and the weldment finite element model in the next iteration based on the process parameters adjusted, and returning to the step of “applying a contact relationship and a mechanical action relationship between the stirring tool finite element model and the weldment finite element model and applying a contact relationship and a mechanical action relationship between the roller finite element model and the weldment finite element model in the system finite element model to obtain a system finite element model comprising contact relationships and mechanical action relationships”; wherein the process parameters comprise a distance between the roller finite element model and the stirring tool finite element model, a magnitude of the vertical mechanical action force applied to the roller finite element model and a friction coefficient between the roller finite element model and the weldment finite element model.

In a second aspect, the present disclosure provides a device for optimizing process parameters of friction stir welding with synchronous rolling, where the device for optimizing process parameters of friction stir welding with synchronous rolling includes:
a model establishing module configured to establish a system finite element model of the friction stir welding with synchronous rolling; wherein the system finite element model comprises a roller finite element model, a stirring tool finite element model and a weldment finite element model, the roller finite element model and the stirring tool finite element model are arranged perpendicularly to the weldment finite element model, the roller finite element model and the stirring tool finite element model are in contact with an upper surface of a welding seam position of the weldment finite element model, and the roller finite element model and the stirring tool finite element model are arranged at intervals;
a first application module configured to apply a heat source model to the system finite element model to obtain a system finite element model comprising the heat source model; wherein the heat source model is a model equivalent to friction heat generation of a real stirring tool;
a first simulation module configured to perform a heat transfer simulation on a welding process and a cooling process of friction stir welding by using the system finite element model comprising the heat source model to obtain a temperature field result of a real weldment; wherein the temperature field result comprises a temperature field of the real weldment at each moment in the welding process and the cooling process;
a second application module configured to apply a contact relationship and a mechanical action relationship between the stirring tool finite element model and the weldment finite element model and apply a contact relationship and a mechanical action relationship between the roller finite element model and the weldment finite element model in the system finite element model to obtain a system finite element model comprising contact relationships and mechanical action relationships; wherein the contact relationship between the stirring tool finite element model and the weldment finite element model is a frictionless surface-to-surface contact relationship, the mechanical action relationship between the stirring tool finite element model and the weldment finite element model is to apply a vertical mechanical action force to the stirring tool finite element model, the contact relationship between the roller finite element model and the weldment finite element model is a frictional surface-to-surface contact relationship, and the mechanical action relationship between the roller finite element model and the weldment finite element model is to apply a vertical mechanical action force to the roller finite element model;
a second simulation module configured to perform a thermal-mechanical simulation on the welding process, the cooling process and a clamp release process of the friction stir welding with synchronous rolling by using the system finite element model comprising the contact relationships and the mechanical action relationships, with the temperature field result as an input, so as to obtain a welding stress result and a welding deformation result of the real weldment; wherein the welding stress result comprises a welding stress field of the real weldment at each moment in the welding process, the cooling process and the clamp release process; and the welding deformation result comprises a welding deformation field of the real weldment at each moment in the welding process, the cooling process and the clamp release process; and
a parameter optimization module configured to determine whether an iteration termination condition is met; in response to a determination that the iteration termination condition is met, deem process parameters used in a current iteration as optimized process parameters; in response to a determination that the iteration termination condition is not met, adjust the process parameters used in the current iteration based on the welding stress result and the welding deformation result, and determine the system finite element model in a next iteration and the contact relationship and the mechanical action relationship between the roller finite element model and the weldment finite element model in the next iteration based on the process parameters adjusted, and return to the step of “applying a contact relationship and a mechanical action relationship between the stirring tool finite element model and the weldment finite element model and applying a contact relationship and a mechanical action relationship between the roller finite element model and the weldment finite element model in the system finite element model to obtain a system finite element model comprising contact relationships and mechanical action relationships”; wherein the process parameters comprise a distance between the roller finite element model and the stirring tool finite element model, a magnitude of the vertical mechanical action force applied to the roller finite element model and a friction coefficient between the roller finite element model and the weldment finite element model.

In a third aspect, the present disclosure provides a computer device, including a memory, a processor and a computer program stored in the memory and executable on the processor, where the processor executes the computer program to implement the method for optimizing process parameters of friction stir welding with synchronous rolling.

In a fourth aspect, the present disclosure provides a computer-readable storage medium on which a computer program is stored, where the computer program, when executed by a processor, implements the method for optimizing process parameters of friction stir welding with synchronous rolling.

In a fifth aspect, the present disclosure provides a computer program product, including a computer program, where the computer program, when executed by a processor, implements the method for optimizing process parameters of friction stir welding with synchronous rolling.

According to the specific embodiment provided by the present disclosure, the present disclosure discloses the following technical effects.

The present disclosure provides a method for optimizing process parameters of friction stir welding with synchronous rolling and a related device. A heat source model is applied to a system finite element model of friction stir welding with synchronous rolling, and heat transfer simulation is performed on a welding process and a cooling process of friction stir welding to obtain the temperature field result of a real weldment. On this basis, furthermore, a contact relationship and a mechanical action relationship between a stirring tool finite element model and a weldment finite element model and a contact relationship and a mechanical action relationship between a roller finite element model and the weldment finite element model are applied in the system finite element model of friction stir welding with synchronous rolling. Thermal-mechanical simulation is performed on the welding process, the cooling process and a clamp release process of friction stir welding with synchronous rolling with the temperature field result as input, so as to obtain a welding stress result and a welding deformation result of the real weldment. Based on the welding stress result and the welding deformation result, process parameters can be adjusted, so that optimal process parameters in which synchronous rolling during welding is used to perform the welding accompanied by straightening control on friction stir welding can be determined, which can effectively reduce welding deformation of friction stir welding.

### BRIEF DESCRIPTION OF THE DRAWINGS

In order to more clearly explain the technical solution in the embodiments of the present disclosure or the prior art, the drawings needed to be used in the embodiments will be briefly introduced hereinafter. Apparently, the drawings in the following description are only some embodiments of the present disclosure. For those skilled in the art, other drawings can be obtained according to these drawings without paying creative labor.

FIG. 1 is a schematic flow chart of a method for optimizing process parameters of friction stir welding with synchronous rolling according to Embodiment 1 of the present disclosure.

FIG. 2 is a schematic diagram of a system geometric structure model of friction stir welding with synchronous rolling according to Embodiment 1 of the present disclosure.

FIG. 3 is a detailed flow diagram of the method for optimizing process parameters of friction stir welding with synchronous rolling according to Embodiment 1 of the present disclosure.

FIG. 4 is a schematic functional module diagram of a device for optimizing process parameters of friction stir welding with synchronous rolling according to Embodiment 2 of the present disclosure.

FIG. 5 is a schematic structural diagram of a computer device according to Embodiment 3 of the present disclosure.

### DESCRIPTION OF REFERENCE NUMBERS

1—roller geometric structure model; 2—stirring tool geometric structure model; 3—weldment geometric structure model; 4—welding seam position.

### DETAILED DESCRIPTION OF THE EMBODIMENTS

In the following, the technical solution in the embodiment of the present disclosure will be clearly and completely described with reference to the drawings in the embodiment of the present disclosure. Apparently, the described embodiments are only some of the embodiments of the present disclosure, rather than all of the embodiments. Based on the embodiments in the present disclosure, all other embodiments obtained by those skilled in the art without paying creative labor belong to the scope of protection of the present disclosure.

In order to make the above objectives, features and advantages of the present disclosure more obvious and understandable, the present disclosure will be further described in detail with reference to the drawings and the detailed description.

### Embodiment 1

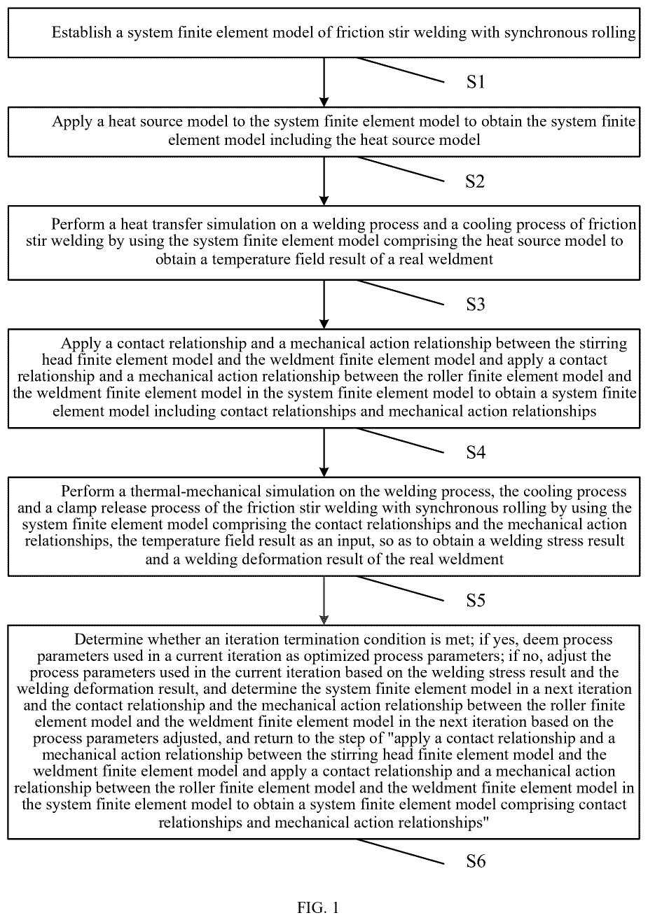

As shown in FIG. 1, this embodiment provides a method for optimizing process parameters of friction stir welding with synchronous rolling. The method for optimizing process parameters of friction stir welding with synchronous rolling includes the following steps S1 to S6.

In step S1, a system finite element model of friction stir welding with synchronous rolling is established. The system finite element model includes a roller finite element model, a stirring tool finite element model and a weldment finite element model. The roller finite element model and the stirring tool finite element model are arranged perpendicularly to the weldment finite element model. The roller finite element model and the stirring tool finite element model are in contact with an upper surface of a welding seam position of the weldment finite element model, and the roller finite element model and the stirring tool finite element model are arranged at intervals.

In step S1, the establishing a system finite element model of friction stir welding with synchronous rolling specifically includes the following steps (1) to (2).

In step (1), a system geometric structure model of friction stir welding with synchronous rolling is established.

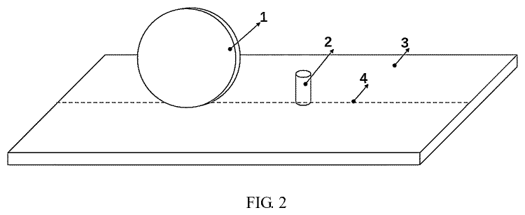

As shown in FIG. 2, the system geometric structure model of friction stir welding with synchronous rolling includes a roller geometric structure model 1, a stirring tool geometric structure model 2 and a weldment geometric structure model 3. The roller geometric structure model 1 and the stirring tool geometric structure model 2 are arranged perpendicularly to the weldment geometric structure model 3. The roller geometric structure model 1 and the stirring tool geometric structure model 2 are in contact with the upper surface of the welding seam position 4 of the weldment geometric structure model 3, and the roller geometric structure model 1 and the stirring tool geometric structure model 2 are arranged at intervals. The spacing between the roller geometric structure model 1 the stirring tool geometric structure model 2 in the direction of the welding seam position 4 is consistent with the real (or physical) spacing therebetween, and the spacing is an adjustable process parameter.

The structure and the size of the roller geometric structure model 1 are the same as those of the actual roller. The structure of the stirring tool geometric structure model 2 is a cylinder. The diameter of the stirring tool geometric structure model 2 is the same as that of a stirring part of the real stirring tool. The real stirring tool includes the stirring part and the stirring pin. The structure and the size of the weldment geometric structure model 3 are the same as those of the real weldment.

(2) The roller geometric structure model is set as a rigid body model to obtain the roller finite element model; the stirring tool geometric structure model is set as a rigid body model to obtain the stirring tool finite element model; the weldment geometric structure model is set as a flexible body model, a material property of the weldment geometric structure model is set, and meshing is performed on the weldment geometric structure model, so as to obtain the weldment finite element model; and the system finite element model of friction stir welding with synchronous rolling is formed by the roller finite element model, the stirring tool finite element model and the weldment finite element model.

The material property of the weldment geometric structure model is set, specifically including: setting the material property of the weldment geometric structure model according to the actual welding situation, such as aluminum, and copper.

Meshing the weldment geometric structure model specifically includes: dividing the weldment geometric structure model into a first area and a second area, where the first area refers to an area with the welding seam position as a center line and having the length same as that of the weldment geometric structure model and the width of a predetermined value, and the second area refers to other areas in the weldment geometric structure model except the first area; and meshing the first area according to a principle of uniform mesh size, and meshing the second area according to a principle that the farther away from the welding seam position, the larger the mesh size; where a size of a smallest mesh obtained by meshing the second area is larger than a size of a mesh obtained by meshing the first area.

In this embodiment, the predetermined value can be twice the diameter of the stirring part of the real stirring tool. The sizes of the meshes obtained by meshing the first area are all the same, which can be a value not more than 1/10 of the diameter of the stirring part of the real stirring tool. The sizes of the meshes obtained by meshing the second area are different, the size of the smallest mesh is larger than the size of the mesh obtained by meshing the first area, and the size of the largest mesh is not larger than 20 mm.

In step S2, a heat source model is applied to the system finite element model to obtain the system finite element model including the heat source model. The heat source model is a model equivalent to friction heat generation of a real stirring tool.

In step S2, the heat source model is a composite heat source including a uniformly distributed torus heat source and a uniformly distributed cylinder heat source. An axis of the uniformly distributed torus heat source is coaxial with an axis of the uniformly distributed cylinder heat source. Moreover, the uniformly distributed torus heat source is coplanar with an upper surface of the uniformly distributed cylinder heat source, and the upper surface of the uniformly distributed cylinder heat source is a circular surface.

An inner radius of the uniformly distributed torus heat source is the same as a radius of a stirring pin of the real stirring tool, and an outer radius of the uniformly distributed torus heat source is the same as a radius of the stirring part of the real stirring tool. A radius of the uniformly distributed cylinder heat source is the same as the radius of the stirring pin of the real stirring tool, and a height of the uniformly distributed cylinder heat source is the same as a height of the stirring pin of the real stirring tool.

In step S2, a heat source model is applied to the system finite element model, which specifically includes: applying the heat source model to the upper surface and the interior of the weldment finite element model of the system finite element model. The uniformly distributed torus heat source of the heat source model is coplanar with the upper surface of the weldment finite element model and applied to the upper surface of the weldment finite element model. The uniformly distributed cylinder heat source of the heat source model is located inside the weldment finite element model and applied to the cylinder inside the weldment finite element model.

S3: The system finite element model including the heat source model is used to perform a heat transfer simulation on a welding process and a cooling process of friction stir welding to obtain a temperature field result of a real weldment. The temperature field result includes a temperature field of the real weldment at each moment in the welding process and the cooling process.

Because a simulation model of the weldment finite element simulates the real weldment, the temperature field result of the weldment finite element model is the temperature field result of the real weldment. In step S3, the temperature field includes the temperature of the real weldment at each position point.

In step S3, the system finite element model including the heat source model is used to perform a heat transfer simulation on a welding process and a cooling process of friction stir welding to obtain a temperature field result of a real weldment, which specifically includes: applying a convection boundary condition and a radiation boundary condition in the system finite element model including the heat source model; controlling the heat source model to move along the welding seam position at a predetermined moving speed, so as to simulate the welding process of friction stir welding, and simultaneously performing heat transfer analysis to obtain the temperature field of the real weldment at each moment in the welding process; and stopping applying the heat source model after completing welding to simulate the cooling process of friction stir welding, and simultaneously performing heat transfer analysis to obtain the temperature field of the real weldment at each moment in the cooling process.

During actual welding, a clamp is arranged to fix the weldment finite element model, and a backing plate is arranged to support the weldment finite element model. According to the actual positions of the clamp and the backing plate, a first convection boundary condition is applied at the positions corresponding to the actual positions of the clamp and the backing plate in the system finite element model including the heat source model. A second convection boundary condition and a radiation boundary condition are applied in other positions in the system finite element model including the heat source model, so as to apply the convection boundary condition and the radiation boundary condition in the system finite element model including the heat source model.

In step S4, a contact relationship and a mechanical action relationship between the stirring tool finite element model and the weldment finite element model and a contact relationship and a mechanical action relationship between the roller finite element model and the weldment finite element model are applied in the system finite element model to obtain a system finite element model including the contact relationships and the mechanical action relationships. The contact relationship between the stirring tool finite element model and the weldment finite element model is a frictionless surface-to-surface contact relationship. The mechanical action relationship between the stirring tool finite element model and the weldment finite element model is to apply a vertical mechanical action force to the stirring tool finite element model. The contact relationship between the roller finite element model and the weldment finite element model is a frictional surface-to-surface contact relationship. The mechanical action relationship between the roller finite element model and the weldment finite element model is to apply a vertical mechanical action force to the roller finite element model.

In step S5, the system finite element model including the contact relationships and the mechanical action relationships is used to perform thermal-mechanical simulation on the welding process, the cooling process and a clamp release process of friction stir welding with synchronous rolling with the temperature field result as input, so as to obtain a welding stress result and a welding deformation result of the real weldment. The welding stress result includes a welding stress field of the real weldment at each moment in the welding process, the cooling process and the clamp release process. The welding deformation result includes a welding deformation field of the real weldment at each moment in the welding process, the cooling process and the clamp release process.

In step S5, the welding stress field includes the welding stress of the real weldment at each position point, and the welding deformation field includes the welding deformation of the real weldment at each position point.

In step S5, the system finite element model including the contact relationships and the mechanical action relationships is used to perform thermal-mechanical simulation on the welding process, the cooling process and a clamp release process of friction stir welding with synchronous rolling with the temperature field result as an input, so as to obtain a welding stress result and a welding deformation result of the real weldment, which specifically includes: applying a clamp constraint and a backing plate constraint in the system finite element model including the contact relationships and the mechanical action relationships, where the clamp is configured to fix the weldment finite element model, and the backing plate is configured to support the weldment finite element model; controlling the roller finite element model and the stirring tool finite element model to move along the welding seam position at a predetermined moving speed, so as to simulate the welding process of friction stir welding with synchronous rolling, and simultaneously performing thermal-mechanical analysis with the temperature field of the real weldment at each moment in the welding process as an input, so as to obtain the welding stress field and the welding deformation field of the real weldment at each moment in the welding process; controlling the roller finite element model and the stirring tool finite element model simultaneously to stop moving after completing welding, so as to simulate the cooling process of friction stir welding with synchronous rolling, and simultaneously performing thermal-mechanical analysis with the temperature field of the real weldment at each moment in the cooling process as an input, so as to obtain the welding stress field and the welding deformation field of the real weldment at each moment in the cooling process; and removing the clamp after completing cooling, so as to simulate the clamp release process of friction stir welding with synchronous rolling, and simultaneously performing elastic-plastic mechanical analysis, so as to obtain the welding stress field and the welding deformation field of the real weldment at each moment in the clamp release process.

Applying a clamp constraint and a backing plate constraint specifically includes: setting the partial displacement of the meshes in the position where the clamp and the backing plate in the weldment finite element model are located, as 0. The direction in which the displacement is 0 is the same as the direction of action of the clamp and the backing plate. For example, if the clamp is configured to limit the vertical displacement of the weldment finite element model, the vertical displacement of the meshes in the position where the clamp in the weldment finite element model is located is 0.

In step S6, it is determined whether an iteration termination condition is met; if yes, process parameters used in the current iteration are used as the optimized process parameters; if not, the process parameters used in the current iteration are adjusted based on the welding stress result and the welding deformation result, the system finite element model in a next iteration and the contact relationship and the mechanical action relationship between the roller finite element model and the weldment finite element model in the next iteration are determined based on the adjusted process parameters, and the method returns to the step of “applying a contact relationship and a mechanical action relationship between the stirring tool finite element model and the weldment finite element model and applying a contact relationship and a mechanical action relationship between the roller finite element model and the weldment finite element model in the system finite element model to obtain a system finite element model including the contact relationships and the mechanical action relationships”. The process parameters include a distance between the roller finite element model and the stirring tool finite element model, the magnitude of the vertical mechanical action force applied to the roller finite element model and the friction coefficient between the roller finite element model and the weldment finite element model.

In step S6, the iteration termination condition is that the change of the maximum welding deformation value of two adjacent iterations meets the requirements, or the process parameters reach the edge of the feasible process window, and the feasible process window is the value ranges of the self-defined process parameters.

The change of the maximum welding deformation value of two adjacent iterations meets the requirements as follows:

$$\vert \frac{{u}_{i} - {u}_{i - 1}}{{u}_{i - 1}} \vert \leq 5 \% , i = 2 , 3 … ;$$

where uᵢ is a maximum welding deformation value calculated by an i-th iteration, which is determined according to the welding deformation result of the i-th iteration; uᵢ₋₁ is a maximum welding deformation value calculated by the (i−1)-th iteration, which is determined according to the welding deformation result of the (i−1)-th iteration; and i is the serial number of analysis and calculation. From the second iteration, the above conditions are applied to determine whether the change meets the requirements.

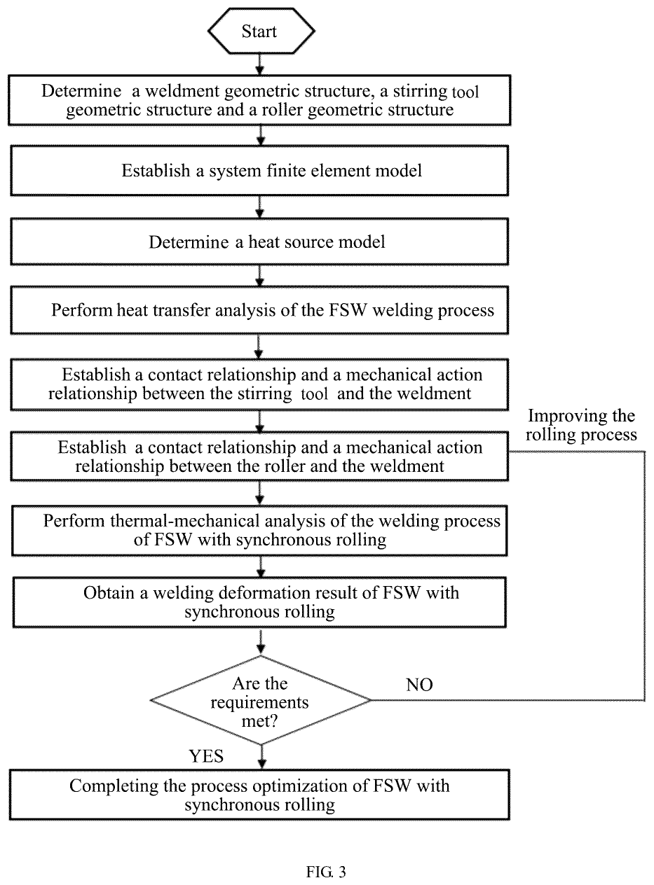

As shown in FIG. 3, FIG. 3 is a detailed flow chart of a method for optimizing process parameters of friction stir welding with synchronous rolling according to this embodiment. The method for optimizing process parameters of friction stir welding with synchronous rolling according to this embodiment will be further illustrated hereinafter with reference to FIG. 3.

Step 1: According to the actual situation of friction stir welding with synchronous rolling, the weldment geometric structure model, the stirring tool geometric structure model and the roller geometric structure model are established to obtain the weldment geometric structure model, the stirring tool geometric structure model and the roller geometric structure model, respectively. The structures and the sizes of the roller geometric structure model and the weldment geometric structure model are the same as those of the real roller and weldment. The structure of the stirring tool geometric structure model is simplified to a flat-headed cylinder with the same radius as the stirring part of the real stirring tool. The length of the stirring tool geometric structure model and the length of the stirring part may be the same or different. The real stirring tool includes a stirring part and a stirring pin. The stirring part and the stirring pin are cylinders. The stirring part and the stirring pin are coaxial with each other, and the lower circular surface of the stirring part is connected with the upper circular surface of the stirring pin. The roller geometric structure model and the stirring tool geometric structure model are set to be perpendicular to the weldment geometric structure model. At the same time, the roller geometric structure model and the stirring tool geometric structure model are set to be in contact with the upper surface of the welding seam position of the weldment geometric structure model. The spacing between the roller geometric structure model and the stirring tool geometric structure model in the direction of the welding seam position is set to be the same as that between the real roller and weldment, so as to obtain the system geometric structure model of friction stir welding with synchronous rolling.

In step 2, the system finite element model of friction stir welding with synchronous rolling including a stirring tool finite element model and a roller finite element model is established. Each of the roller geometric structure model and the stirring tool geometric structure model is set as a rigid body to obtain the roller finite element model and the stirring tool finite element model without meshing. The weldment geometric structure model is set as a flexible body model. The material property of the weldment geometric structure model is set. The meshing strategy of the weldment geometric structure model is determined according to the size of the stirring part of the real stirring tool of friction stir welding, so as to establish a multi-scale finite element mesh model of the weldment geometric structure model and obtain the weldment finite element model. The roller finite element model, the stirring tool finite element model and the weldment finite element model forms the system finite element model of friction stir welding with synchronous rolling. When meshing the weldment geometric structure model, it is determined that the fine mesh area (that is, the first area) of the weldment geometric structure model is an area with the welding seam position as a center line and having the same length as that of the weldment geometric structure model and the width (that is, the predetermined value) twice the diameter of the stirring part of the real stirring tool. A three-dimensional fine mesh is divided in the first area, and the sizes of the meshes are not more than 1/10 of the diameter of the stirring part of the real stirring tool. In the weldment geometric structure model, the area (that is, the second area) except the fine mesh area is divided into transition meshes from being dense to being sparse with the increasing distance from the welding seam position. The size of the smallest mesh is larger than the size of the mesh obtained by meshing the first area, and the size of the largest mesh is not larger than 20 mm.

In step 3, the heat source model is determined according to the welding characteristics of friction stir welding. The heat source model is a composite heat source consisting of a uniformly distributed torus heat source and a uniformly distributed cylinder heat source. The uniformly distributed torus heat source is coaxial with the uniformly distributed cylinder heat source. The uniformly distributed torus heat source is coplanar with an upper circular surface of the uniformly distributed cylinder heat source. The inner radius of the uniformly distributed torus heat source is the same as the radius of a stirring pin of the real stirring tool, and the outer radius thereof is the same as the radius of the stirring part of the real stirring tool. The radius and the height of the uniformly distributed cylinder heat source are the same as those of the stirring pin of the real stirring tool, respectively.

In step 4, for the system finite element model established in Step 2, the composite heat source determined in Step 3 is applied according to the actual welding process to obtain the system finite element model including the heat source model. The moving speed of the heat source model is controlled. The convection boundary condition and the radiation boundary condition are applied according to the positions of the backing plate and the clamp. The heat transfer analysis of the welding process and the cooling process of friction stir welding is performed to obtain the temperature field results of the real weldment in the welding process and the cooling process.

In step 5, in the system finite element model established in Step 2, the contact relationship and the mechanical action relationship between the stirring tool finite element model and the weldment finite element model are applied. In this embodiment, the function of the stirring tool finite element model is to provide the vertical mechanical action force on the weldment finite element model. Therefore, according to the actual control method (displacement control or force control), vertical fixed displacement or a vertical concentrated force is applied to the stirring tool finite element model to complete the application of the mechanical action relationship between the stirring tool finite element model and the weldment finite element model. At the same time, the relationship between the stirring tool finite element model and the weldment finite element model is simplified as a frictionless surface-to-surface contact relationship, in which in the normal direction of the contact surface, the contact surface is set to be hard contact without a penetration behavior, and in the tangential direction, the contact surface is set to be a frictionless contact, thus completing the application of the contact relationship between the stirring tool finite element model and the weldment finite element model.

In step 6, in the system finite element model established in Step 5, the contact relationship and the mechanical action relationship between the roller finite element model and the weldment finite element model are applied. In this embodiment, the function of the roller finite element model is to provide dual actions of “rolling” and “pressing” on the weldment finite element model. Therefore, according to the actual control method (displacement control or force control), vertical fixed displacement or a vertical concentrated force is applied to the roller finite element model to complete the application of the mechanical action relationship between the roller finite element model and the weldment finite element model. At the same time, the relationship between the roller finite element model and the weldment finite element model is set as a frictional surface-to-surface contact relationship, in which in the normal direction of the contact surface, the contact surface is set to be hard contact without a penetration behavior, and in the tangential direction, the contact surface is set to be frictional contact, and further the friction coefficient is determined by the actual material, thus completing the application of the contact relationship between the roller finite element model and the weldment finite element model.

In step 7, for the system finite element model the contact relationship and the mechanical action relationship established in Step 6, according to the actual welding clamping situation, the clamp constraint and the backing plate constraint are applied. According to the actual welding situation, the moving speed, the speed magnitude and the direction of the stirring tool finite element model are given to be the same as that of the heat source model in Step 4. The rotational degree of freedom of the roller finite element model is released. The moving speed of the roller finite element model is given, and the speed magnitude and the direction of the roller finite element model are the same as that of the heat source model in Step 4. The thermal-mechanical analysis is performed by using a mechanical analysis software in combination with the temperature field result obtained in Step 4. The welding stress result and the welding deformation result of the real weldment are obtained from calculation. The change of the welding stress and the welding deformation in the welding process are analyzed manually. The influence mechanism of rolling on the welding stress and the welding deformation is analyzed manually, and a preliminary optimization solution is developed to reduce the welding deformation.

In step 8, according to the preliminary optimization solution, the rolling process parameters (including the magnitude of the vertical mechanical action force applied to the roller finite element model, the distance between the roller finite element model and the stirring tool finite element model, and the tangential friction coefficient between the roller finite element model and the weldment finite element model) are adjusted, and analysis and calculation are performed again. If the change of the welding deformation meets the requirements or the process parameters reach the limits of the feasible process window, the process optimization is completed. If the requirements are not met and the process parameters fall within the feasible process window, the process parameters are further modified.

Although the friction stir welding technology has the characteristics of small deformation, considerable welding deformation will still occur after welding for large-size thin-walled weldments or special-shaped weldments with thin-walled structures. Synchronous rolling control during welding is a technology that can reduce welding deformation, but it is time-consuming and costly to obtain the optimal process parameters through experiments. Therefore, it is an effective way to implement the process control by effective simulation prediction and process optimization through the computer simulation technology. According to the actual situation of friction stir welding with synchronous rolling and based on the theory of thermo-elastic-plastic solid mechanics, in this embodiment, a system finite element model including a weldment finite element model, a stirring tool finite element model and a roller finite element model is established. In the system finite element model, the stirring tool finite element model and the roller finite element model are rigid bodies, and the weldment finite element model is a flexible body. Moreover, the contact relationship and the mechanical action relationship between the weldment finite element model and the stirring tool finite element model, and the contact relationship and the mechanical action relationship between the weldment finite element model and the roller finite element model are established. Specifically, the frictionless contact relationship between the stirring tool finite element model and the weldment finite element model is established, and the vertical mechanical action relationship between the stirring tool finite element model and the weldment finite element model is established by applying vertical fixed displacement or a vertical concentrated force to the stirring tool finite element model. The friction contact relationship between the roller finite element model and the weldment finite element model is established. The vertical and tangential mechanical action relationship between the roller finite element model and the weldment finite element model are established by applying vertical fixed displacement or a vertical concentrated force to the roller finite element model, and releasing the rotational degree of freedom of the roller finite element model, so as to achieve the dual actions of rolling and pressing of the roller finite element model on the weldment finite element model. Because the actions between the roller finite element model and the weldment finite element model and the action between the stirring tool finite element model and the weldment finite element model are the same as the actual conditions, a high-fidelity method for predicting the welding stress and the welding deformation of friction stir welding with synchronous rolling is designed, and based on the high-fidelity method, a method for optimizing process parameters of friction stir welding with synchronous rolling is established. First, for the weldment geometric structure model, a surface-body composite heat source model of friction stir welding is applied, heat transfer analysis is performed, and the temperature field result of the real weldment is calculated. On this basis, the thermal-mechanical analysis is performed on the system finite element model including the stirring tool finite element model and the roller finite element model, and the welding stress result and the welding deformation result of the real weldment is obtained from calculation. On the basis of the welding stress result and the welding deformation result, the rolling process parameters are optimized, and iteration is continuously performed to obtain the optimal process parameters.

This embodiment further provides an application scenario, which applies the method for optimizing process parameters of friction stir welding with synchronous rolling. Specifically, the method for optimizing process parameters of friction stir welding with synchronous rolling provided by this embodiment can be applied to the scenario in which the weldment is processed using the process for friction stir welding with synchronous rolling. The scenario includes a process parameter optimization link and an actual welding link. The method for optimizing process parameters of friction stir welding with synchronous rolling provided by this embodiment belongs to the process parameter optimization link. The optimal process parameters obtained from the process parameter optimization link are transferred to the actual welding link, and the weldment is actually processed according to the optimal process parameters in the actual welding link, thus reducing the welding deformation of the weldments and improving the welding effect.

The existing simulation methods about the welding accompanied by straightening are all aimed at traditional fusion welding. However, this embodiment is aimed at the technology of friction stir welding with synchronous rolling. A high-fidelity prediction method of welding deformation and a method for optimizing process parameters thereof are designed based on the theory of thermo-elastic-plastic solid mechanics. The advantages of this method are as follows.
(1) In the simulation analysis aspect of friction stir welding: At present, many welding deformation prediction methods can be roughly divided into two types. One type is to ignore the vertical mechanical action force of the stirring tool, so that bulge deformation occurs at the welding seam position, which is inconsistent with the actual situation. The other type is to simplify the vertical mechanical action force of the stirring tool as a uniformly distributed force load. This application method will lead to the problem of an excessive local vertical force applied at the center of the welding seam position, which deviates from the actual situation. In the method for optimizing process parameters of this embodiment, the structure model of the stirring tool is added, and the vertical mechanical action force of the stirring tool finite element model on the weldment finite element model is implemented through the contact relationship and the mechanical action relationship, which is more consistent with the actual situation. That is, in the welding simulation process of this embodiment, the vertical mechanical action of the stirring tool finite element model on the weldment finite element model is added through the contact relationship and the mechanical action relationship, which is more consistent with the actual welding situation.
(2) In the welding simulation process, the vertical and tangential mechanical actions of the roller finite element model on the weldment finite element model are implemented through the contact relationship and the mechanical action relationship, so as to achieve the dual actions of rolling and pressing.
(3) Because the actions of the roller finite element model on the weldment finite element model and the actions of the stirring tool finite element model on the weldment finite element model are more consistent with the actual situation, this is a high-fidelity simulation method. Based on the high-fidelity simulation method, parameter influence analysis and process optimization are performed, which provides theoretical guidance for the process control of friction stir welding with synchronous rolling.

This embodiment aims to meet the high standard requirements for welding quality in the fields such as aerospace and national defense. Based on the theory of thermo-elastic-plastic solid mechanics, it establishes the system finite element model of friction stir welding with synchronous rolling including the weldment structure model, the stirring tool structure model and the roller structure model, and establishes the contact relationship and the mechanical action relationship between the weldment finite element model and the stirring tool finite element model, and the contact relationship and the mechanical action relationship between the weldment finite element model and the roller finite element model. Furthermore, it designs a high-fidelity method for predicting the welding stress and the welding deformation of friction stir welding with synchronous rolling, and establishes a method for optimizing process parameters based on this, which can obtain the optimal process parameters and effectively reduce welding deformation of friction stir welding.

### Embodiment 2

Based on the same inventive concept, this embodiment further provides a device for optimizing process parameters of friction stir welding with synchronous rolling, which is used to implement the method for optimizing process parameters of friction stir welding with synchronous rolling in Embodiment 1. The solution to the problem provided by the device is similar to the solution described in the above method. Therefore, the specific definition of one or more embodiments of the device for optimizing the process parameters of friction stir welding with synchronous rolling provided hereinafter can refer to the above definition of the method for optimizing the process parameters of friction stir welding with synchronous rolling, which will not be described in detail here.

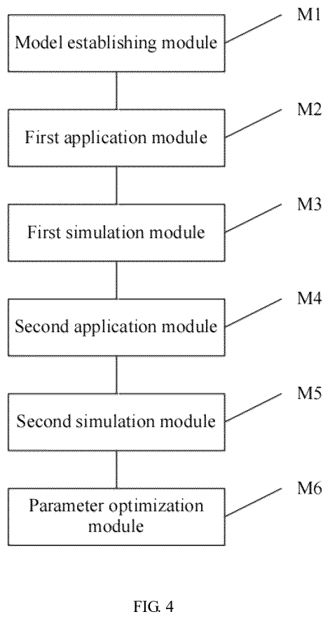

In an exemplary embodiment, as shown in FIG. 4, there is provided a device for optimizing process parameters of friction stir welding with synchronous rolling. The device for optimizing process parameters of friction stir welding with synchronous rolling includes:
a model establishing module M1, which is configured to establish a system finite element model of friction stir welding with synchronous rolling; where the system finite element model includes a roller finite element model, a stirring tool finite element model and a weldment finite element model, the roller finite element model and the stirring tool finite element model are arranged perpendicularly to the weldment finite element model, the roller finite element model and the stirring tool finite element model are in contact with an upper surface of a welding seam position of the weldment finite element model, and the roller finite element model and the stirring tool finite element model are arranged at intervals;
a first application module M2, which is configured to apply a heat source model to the system finite element model to obtain the system finite element model including the heat source model; where the heat source model is a model equivalent to friction heat generation of a real stirring tool;
a first simulation module M3, which is configured to perform heat transfer simulation on a welding process and a cooling process of friction stir welding by using the system finite element model comprising the heat source model to obtain a temperature field result of a real weldment; where the temperature field result includes a temperature field of the real weldment at each moment in the welding process and the cooling process;
a second application module M4, which is configured to apply a contact relationship and a mechanical action relationship between the stirring tool finite element model and the weldment finite element model and apply a contact relationship and a mechanical action relationship between the roller finite element model and the weldment finite element model in the system finite element model to obtain a system finite element model including the contact relationships and the mechanical action relationships; where the contact relationship between the stirring tool finite element model and the weldment finite element model is a frictionless surface-to-surface contact relationship, the mechanical action relationship between the stirring tool finite element model and the weldment finite element model is to apply a vertical mechanical action force to the stirring tool finite element model, the contact relationship between the roller finite element model and the weldment finite element model is a frictional surface-to-surface contact relationship, and the mechanical action relationship between the roller finite element model and the weldment finite element model is to apply a vertical mechanical action force to the roller finite element model;

a second simulation module M5, which is configured to perform thermal-mechanical simulation on the welding process, the cooling process and a clamp release process of friction stir welding with synchronous rolling by using the system finite element model comprising contact relationships and mechanical action relationships, with the temperature field result as an input, so as to obtain a welding stress result and a welding deformation result of the real weldment; where the welding stress result includes a welding stress field of the real weldment at each moment in the welding process, the cooling process and the clamp release process; and the welding deformation result includes a welding deformation field of the real weldment at each moment in the welding process, the cooling process and the clamp release process;
a parameter optimization module M6, which is configured to determine whether an iteration termination condition is met; if yes, use process parameters used in the current iteration as the optimized process parameters; if not, adjust the process parameters used in the current iteration based on the welding stress result and the welding deformation result, and determine the system finite element model in a next iteration and the contact relationship and the mechanical action relationship between the roller finite element model and the weldment finite element model in the next iteration based on the adjusted process parameters, and return to the step of “applying a contact relationship and a mechanical action relationship between the stirring tool finite element model and the weldment finite element model and applying a contact relationship and a mechanical action relationship between the roller finite element model and the weldment finite element model in the system finite element model to obtain a system finite element model including the contact relationships and the mechanical action relationships”; where the process parameters include a distance between the roller finite element model and the stirring tool finite element model, the magnitude of the vertical mechanical action force applied to the roller finite element model and the friction coefficient between the roller finite element model and the weldment finite element model.

### Embodiment 3

A computer device is provided, including a memory, a processor and a computer program stored in the memory and executable on the processor, where the processor executes the computer program to implement the method for optimizing process parameters of friction stir welding with synchronous rolling according to Embodiment 1.

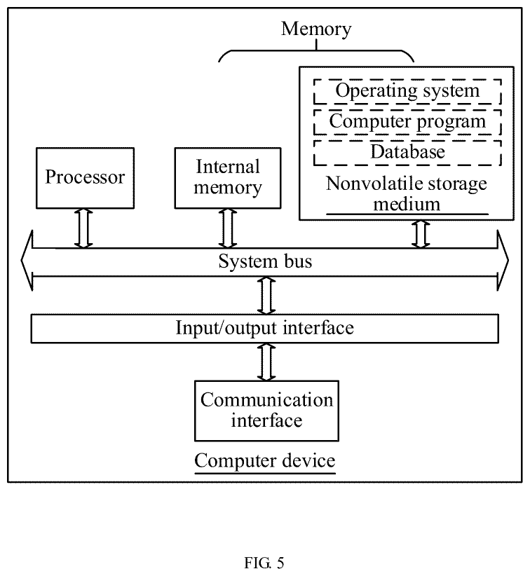

The internal structure diagram of the computer device can be shown in FIG. 5. The computer device includes a processor, a memory, an Input/Output (I/O for short) interface and a communication interface. The processor, the memory and the input/output interface are connected through a system bus, and the communication interface is connected to the system bus through the input/output interface. The processor of the computer device is configured to provide computing and control capabilities. The memory of the computer device includes a nonvolatile storage medium and an internal memory. The nonvolatile storage medium stores an operating system, a computer program and a database. The internal memory provides an environment for the operation of the operating system and the computer program in the nonvolatile storage medium. The input/output interface of the computer device is configured to exchange information between the processor and an external device. The communication interface of the computer device is configured to communicate with an external terminal through network connection. The computer program, when executed by a processor, implements a method for optimizing process parameters of friction stir welding with synchronous rolling.

It can be understood by those skilled in the art that the structure shown in FIG. 5 is only a block diagram of a part of the structure related to the solution of the present disclosure, and does not constitute a limitation on the computer device to which the solution of the present disclosure is applied. The specific computer device may include more or less components than that shown in FIG. 5, or combine some components, or have different component arrangements.

### Embodiment 4

A computer-readable storage medium is provided, on which a computer program is stored, where the computer program, when executed by a processor, implements the method for optimizing process parameters of friction stir welding with synchronous rolling according to Embodiment 1.

### Embodiment 5

A computer program product is provided, including a computer program, where the computer program, when executed by a processor, implements the method for optimizing process parameters of friction stir welding with synchronous rolling according to Embodiment 1.

It should be noted that the user information (including but not limited to user equipment information, user personal information, etc.) and data (including but not limited to data for analysis, stored data, displayed data, etc.) involved in the present disclosure are all information and data authorized by users or fully authorized by all parties, and the collection, use and processing of relevant data must comply with relevant regulations.

The technical features of the above embodiments can be combined at will. In order to make the description concise, not all possible combinations of the technical features in the above embodiments are described. However, as long as there is no contradiction between the combinations of these technical features, the combinations should be considered as the scope described in this specification.

In the present disclosure, specific examples are used to explain the principle and the implementation of the present disclosure, and the description of the above examples is only used to help understand the method and the core idea of the present disclosure. At the same time, for those skilled in the art, according to the idea of the present disclosure, there will be changes in the specific implementation and the application scope. In summary, the contents of this specification should not be construed as limiting the present disclosure.

1. A method for optimizing process parameters of friction stir welding with synchronous rolling, comprising:
establishing a system finite element model of the friction stir welding with synchronous rolling; wherein the system finite element model comprises a roller finite element model, a stirring tool finite element model and a weldment finite element model, the roller finite element model and the stirring tool finite element model are arranged perpendicularly to the weldment finite element model, the roller finite element model and the stirring tool finite element model are in contact with an upper surface of a welding seam position of the weldment finite element model, and the roller finite element model and the stirring tool finite element model are arranged at intervals;
applying a heat source model to the system finite element model to obtain a system finite element model comprising the heat source model; wherein the heat source model is a model equivalent to friction heat generation of a real stirring tool;
performing a heat transfer simulation on a welding process and a cooling process of friction stir welding by using the system finite element model comprising the heat source model to obtain a temperature field result of a real weldment; wherein the temperature field result comprises a temperature field of the real weldment at each moment in the welding process and the cooling process;
applying a contact relationship and a mechanical action relationship between the stirring tool finite element model and the weldment finite element model and applying a contact relationship and a mechanical action relationship between the roller finite element model and the weldment finite element model in the system finite element model to obtain a system finite element model comprising contact relationships and mechanical action relationships; wherein the contact relationship between the stirring tool finite element model and the weldment finite element model is a frictionless surface-to-surface contact relationship, the mechanical action relationship between the stirring tool finite element model and the weldment finite element model is to apply a vertical mechanical action force to the stirring tool finite element model, the contact relationship between the roller finite element model and the weldment finite element model is a frictional surface-to-surface contact relationship, and the mechanical action relationship between the roller finite element model and the weldment finite element model is to apply a vertical mechanical action force to the roller finite element model;
performing a thermal-mechanical simulation on the welding process, the cooling process and a clamp release process of the friction stir welding with synchronous rolling by using the system finite element model comprising the contact relationships and the mechanical action relationships, the temperature field result as an input, so as to obtain a welding stress result and a welding deformation result of the real weldment; wherein the welding stress result comprises a welding stress field of the real weldment at each moment in the welding process, the cooling process and the clamp release process; and the welding deformation result comprises a welding deformation field of the real weldment at each moment in the welding process, the cooling process and the clamp release process; and
determining whether an iteration termination condition is met; in response to a determination that the iteration termination condition is met, deeming process parameters used in a current iteration as optimized process parameters; in response to a determination that the iteration termination condition is not met, adjusting the process parameters used in the current iteration based on the welding stress result and the welding deformation result, and determining the system finite element model in a next iteration and the contact relationship and the mechanical action relationship between the roller finite element model and the weldment finite element model in the next iteration based on the process parameters adjusted, and returning to the step of “applying a contact relationship and a mechanical action relationship between the stirring tool finite element model and the weldment finite element model and applying a contact relationship and a mechanical action relationship between the roller finite element model and the weldment finite element model in the system finite element model to obtain a system finite element model comprising contact relationships and mechanical action relationships”; wherein the process parameters comprise a distance between the roller finite element model and the stirring tool finite element model, a magnitude of the vertical mechanical action force applied to the roller finite element model and a friction coefficient between the roller finite element model and the weldment finite element model.

2. The method for optimizing the process parameters of the friction stir welding with synchronous rolling according to claim 1, wherein the establishing a system finite element model of the friction stir welding with synchronous rolling comprises:
establishing a system geometric structure model of the friction stir welding with synchronous rolling; wherein the system geometric structure model comprises a roller geometric structure model, a stirring tool geometric structure model and a weldment geometric structure model, the roller geometric structure model and the stirring tool geometric structure model are arranged perpendicularly to the weldment geometric structure model, the roller geometric structure model and the stirring tool geometric structure model are in contact with an upper surface of a welding seam position of the weldment geometric structure model, and the roller geometric structure model and the stirring tool geometric structure model are arranged at intervals; a structure and a size of the roller geometric structure model are same as those of the real roller; a structure of the stirring tool geometric structure model is a cylinder, a diameter of the stirring tool geometric structure model is same as that of a stirring part of the real stirring tool; and a structure and a size of the weldment geometric structure model are same as those of the real weldment;
setting the roller geometric structure model as a rigid body model to obtain the roller finite element model;
setting the stirring tool geometric structure model as a rigid body model to obtain the stirring tool finite element model;
setting the weldment geometric structure model as a flexible body model, setting a material property of the weldment geometric structure model, and meshing the weldment geometric structure model, so as to obtain the weldment finite element model; and
forming the system finite element model of the friction stir welding with synchronous rolling by the roller finite element model, the stirring tool finite element model and the weldment finite element model.

3. The method for optimizing the process parameters of the friction stir welding with synchronous rolling according to claim 2, wherein the meshing the weldment geometric structure model comprises:
dividing the weldment geometric structure model into a first area and a second area, wherein the first area refers to an area with the welding seam position as a center line, having a length identical to that of the weldment geometric structure model and a width of a predetermined value, and the second area refers to other areas in the weldment geometric structure model except the first area; and
meshing the first area according to a principle of equal mesh size, and meshing the second area according to a principle that a size of a mesh increases as a distance of the mesh from the welding seam position increases; wherein a size of a smallest mesh obtained by meshing the second area is larger than a size of a mesh obtained by meshing the first area.

4. The method for optimizing the process parameters of the friction stir welding with synchronous rolling according to claim 1, wherein the heat source model is a composite heat source comprising a uniformly distributed torus heat source and a uniformly distributed cylinder heat source, an axis of the uniformly distributed torus heat source is coaxial with an axis of the uniformly distributed cylinder heat source, the uniformly distributed torus heat source is coplanar with an upper surface of the uniformly distributed cylinder heat source, and the upper surface of the uniformly distributed cylinder heat source is a circular surface;
an inner radius of the uniformly distributed torus heat source is same as a radius of a stirring pin of the real stirring tool, and an outer radius of the uniformly distributed torus heat source is same as a radius of the stirring part of the real stirring tool;
a radius of the uniformly distributed cylinder heat source is same as the radius of the stirring pin of the real stirring tool, and a height of the uniformly distributed cylinder heat source is same as a height of the stirring pin of the real stirring tool.

5. The method for optimizing the process parameters of the friction stir welding with synchronous rolling according to claim 1, wherein the performing a heat transfer simulation on a welding process and a cooling process of friction stir welding by using the system finite element model comprising the heat source model to obtain a temperature field result of a real weldment comprises:
applying a convection boundary condition and a radiation boundary condition in the system finite element model comprising the heat source model;
controlling the heat source model to move along the welding seam position at a predetermined moving speed, so as to simulate the welding process of the friction stir welding, and simultaneously performing heat transfer analysis to obtain the temperature field of the real weldment at each moment in the welding process; and
stopping applying the heat source model after completing welding to simulate the cooling process of the friction stir welding, and simultaneously performing heat transfer analysis to obtain the temperature field of the real weldment at each moment in the cooling process.

6. The method for optimizing the process parameters of the friction stir welding with synchronous rolling according to claim 1, wherein the performing a thermal-mechanical simulation on the welding process, the cooling process and a clamp release process of the friction stir welding with synchronous rolling by using the system finite element model comprising the contact relationships and the mechanical action relationships, with the temperature field result as an input, so as to obtain a welding stress result and a welding deformation result of the real weldment, comprises:
applying a clamp constraint and a backing plate constraint in the system finite element model comprising the contact relationships and the mechanical action relationships, wherein the clamp is configured to fix the weldment finite element model, and the backing plate is configured to support the weldment finite element model;
controlling the roller finite element model and the stirring tool finite element model to move along the welding seam position at a predetermined moving speed, so as to simulate the welding process of the friction stir welding with synchronous rolling, and simultaneously performing thermal-mechanical analysis with the temperature field of the real weldment at each moment in the welding process as an input, so as to obtain the welding stress field and the welding deformation field of the real weldment at each moment in the welding process;
controlling the roller finite element model and the stirring tool finite element model simultaneously to stop moving after completing welding, so as to simulate the cooling process of the friction stir welding with synchronous rolling, and simultaneously performing thermal-mechanical analysis with the temperature field of the real weldment at each moment in the cooling process as an input, so as to obtain the welding stress field and the welding deformation field of the real weldment at each moment in the cooling process; and
removing the clamp after completing cooling, so as to simulate the clamp release process of the friction stir welding with synchronous rolling, and simultaneously performing elastic-plastic mechanical analysis, so as to obtain the welding stress field and the welding deformation field of the real weldment at each moment in the clamp release process.

7. A device for optimizing the process parameters of the friction stir welding with synchronous rolling, comprising:
a model establishing module configured to establish a system finite element model of the friction stir welding with synchronous rolling; wherein the system finite element model comprises a roller finite element model, a stirring tool finite element model and a weldment finite element model, the roller finite element model and the stirring tool finite element model are arranged perpendicularly to the weldment finite element model, the roller finite element model and the stirring tool finite element model are in contact with an upper surface of a welding seam position of the weldment finite element model, and the roller finite element model and the stirring tool finite element model are arranged at intervals;
a first application module configured to apply a heat source model to the system finite element model to obtain a system finite element model comprising the heat source model; wherein the heat source model is a model equivalent to friction heat generation of a real stirring tool;
a first simulation module configured to perform a heat transfer simulation on a welding process and a cooling process of friction stir welding by using the system finite element model comprising the heat source model to obtain a temperature field result of a real weldment; wherein the temperature field result comprises a temperature field of the real weldment at each moment in the welding process and the cooling process;
a second application module configured to apply a contact relationship and a mechanical action relationship between the stirring tool finite element model and the weldment finite element model and apply a contact relationship and a mechanical action relationship between the roller finite element model and the weldment finite element model in the system finite element model to obtain a system finite element model comprising contact relationships and mechanical action relationships; wherein the contact relationship between the stirring tool finite element model and the weldment finite element model is a frictionless surface-to-surface contact relationship, the mechanical action relationship between the stirring tool finite element model and the weldment finite element model is to apply a vertical mechanical action force to the stirring tool finite element model, the contact relationship between the roller finite element model and the weldment finite element model is a frictional surface-to-surface contact relationship, and the mechanical action relationship between the roller finite element model and the weldment finite element model is to apply a vertical mechanical action force to the roller finite element model;
a second simulation module configured to perform a thermal-mechanical simulation on the welding process, the cooling process and a clamp release process of the friction stir welding with synchronous rolling by using the system finite element model comprising the contact relationships and the mechanical action relationships, with the temperature field result as an input, so as to obtain a welding stress result and a welding deformation result of the real weldment; wherein the welding stress result comprises a welding stress field of the real weldment at each moment in the welding process, the cooling process and the clamp release process; and the welding deformation result comprises a welding deformation field of the real weldment at each moment in the welding process, the cooling process and the clamp release process; and
a parameter optimization module configured to determine whether an iteration termination condition is met; in response to a determination that the iteration termination condition is met, deem process parameters used in a current iteration as optimized process parameters; in response to a determination that the iteration termination condition is not met, adjust the process parameters used in the current iteration based on the welding stress result and the welding deformation result, and determine the system finite element model in a next iteration and the contact relationship and the mechanical action relationship between the roller finite element model and the weldment finite element model in the next iteration based on the process parameters adjusted, and return to the step of “applying a contact relationship and a mechanical action relationship between the stirring tool finite element model and the weldment finite element model and applying a contact relationship and a mechanical action relationship between the roller finite element model and the weldment finite element model in the system finite element model to obtain a system finite element model comprising contact relationships and mechanical action relationships”; wherein the process parameters comprise a distance between the roller finite element model and the stirring tool finite element model, a magnitude of the vertical mechanical action force applied to the roller finite element model and a friction coefficient between the roller finite element model and the weldment finite element model.

8. A computer device, comprising a memory, a processor and a computer program stored in the memory and executable on the processor, wherein the processor executes the computer program to implement a method for optimizing process parameters of friction stir welding with synchronous rolling, the method comprising:
establishing a system finite element model of the friction stir welding with synchronous rolling;
wherein the system finite element model comprises a roller finite element model, a stirring tool finite element model and a weldment finite element model, the roller finite element model and the stirring tool finite element model are arranged perpendicularly to the weldment finite element model, the roller finite element model and the stirring tool finite element model are in contact with an upper surface of a welding seam position of the weldment finite element model, and the roller finite element model and the stirring tool finite element model are arranged at intervals;
applying a heat source model to the system finite element model to obtain a system finite element model comprising the heat source model; wherein the heat source model is a model equivalent to friction heat generation of a real stirring tool;
performing a heat transfer simulation on a welding process and a cooling process of friction stir welding by using the system finite element model comprising the heat source model to obtain a temperature field result of a real weldment; wherein the temperature field result comprises a temperature field of the real weldment at each moment in the welding process and the cooling process;
applying a contact relationship and a mechanical action relationship between the stirring tool finite element model and the weldment finite element model and applying a contact relationship and a mechanical action relationship between the roller finite element model and the weldment finite element model in the system finite element model to obtain a system finite element model comprising contact relationships and mechanical action relationships: wherein the contact relationship between the stirring tool finite element model and the weldment finite element model is a frictionless surface-to-surface contact relationship, the mechanical action relationship between the stirring tool finite element model and the weldment finite element model is to apply a vertical mechanical action force to the stirring tool finite element model, the contact relationship between the roller finite element model and the weldment finite element model is a frictional surface-to-surface contact relationship, and the mechanical action relationship between the roller finite element model and the weldment finite element model is to apply a vertical mechanical action force to the roller finite element model;
performing a thermal-mechanical simulation on the welding process, the cooling process and a clamp release process of the friction stir welding with synchronous rolling by using the system finite element model comprising the contact relationships and the mechanical action relationships, the temperature field result as an input, so as to obtain a welding stress result and a welding deformation result of the real weldment: wherein the welding stress result comprises a welding stress field of the real weldment at each moment in the welding process. the cooling process and the clamp release process; and the welding deformation result comprises a welding deformation field of the real weldment at each moment in the welding process, the cooling process and the clamp release process; and
determining whether an iteration termination condition is met: in response to a determination that the iteration termination condition is met. deeming process parameters used in a current iteration as optimized process parameters; in response to a determination that the iteration termination condition is not met, adjusting the process parameters used in the current iteration based on the welding stress result and the welding deformation result, and determining the system finite element model in a next iteration and the contact relationship and the mechanical action relationship between the roller finite element model and the weldment finite element model in the next iteration based on the process parameters adjusted, and returning to the step of “applying a contact relationship and a mechanical action relationship between the stirring tool finite element model and the weldment finite element model and applying a contact relationship and a mechanical action relationship between the roller finite element model and the weldment finite element model in the system finite element model to obtain a system finite element model comprising contact relationships and mechanical action relationships”; wherein the process parameters comprise a distance between the roller finite element model and the stirring tool finite element model, a magnitude of the vertical mechanical action force applied to the roller finite element model and a friction coefficient between the roller finite element model and the weldment finite element model.

9. A non-transitory computer-readable storage medium on which a computer program is stored, wherein the computer program, when executed by a processor, implements the method for optimizing the process parameters of the friction stir welding with synchronous rolling according to claim 1.

10. (canceled)

11. The computer device according to claim 8, wherein the establishing a system finite element model of the friction stir welding with synchronous rolling comprises:
establishing a system geometric structure model of the friction stir welding with synchronous rolling; wherein the system geometric structure model comprises a roller geometric structure model, a stirring tool geometric structure model and a weldment geometric structure model, the roller geometric structure model and the stirring tool geometric structure model are arranged perpendicularly to the weldment geometric structure model, the roller geometric structure model and the stirring tool geometric structure model are in contact with an upper surface of a welding seam position of the weldment geometric structure model, and the roller geometric structure model and the stirring tool geometric structure model are arranged at intervals; a structure and a size of the roller geometric structure model are same as those of the real roller; a structure of the stirring tool geometric structure model is a cylinder, a diameter of the stirring tool geometric structure model is same as that of a stirring part of the real stirring tool; and a structure and a size of the weldment geometric structure model are same as those of the real weldment;
setting the roller geometric structure model as a rigid body model to obtain the roller finite element model;
setting the stirring tool geometric structure model as a rigid body model to obtain the stirring tool finite element model;
setting the weldment geometric structure model as a flexible body model, setting a material property of the weldment geometric structure model, and meshing the weldment geometric structure model, so as to obtain the weldment finite element model; and
forming the system finite element model of the friction stir welding with synchronous rolling by the roller finite element model, the stirring tool finite element model and the weldment finite element model.

12. The computer device according to claim 11, wherein the meshing the weldment geometric structure model comprises:
dividing the weldment geometric structure model into a first area and a second area, wherein the first area refers to an area with the welding seam position as a center line, having a length identical to that of the weldment geometric structure model and a width of a predetermined value, and the second area refers to other areas in the weldment geometric structure model except the first area; and
meshing the first area according to a principle of equal mesh size, and meshing the second area according to a principle that a size of a mesh increases as a distance of the mesh from the welding seam position increases; wherein a size of a smallest mesh obtained by meshing the second area is larger than a size of a mesh obtained by meshing the first area.

13. The computer device according to claim 8, wherein the heat source model is a composite heat source comprising a uniformly distributed torus heat source and a uniformly distributed cylinder heat source, an axis of the uniformly distributed torus heat source is coaxial with an axis of the uniformly distributed cylinder heat source, the uniformly distributed torus heat source is coplanar with an upper surface of the uniformly distributed cylinder heat source, and the upper surface of the uniformly distributed cylinder heat source is a circular surface;
an inner radius of the uniformly distributed torus heat source is same as a radius of a stirring pin of the real stirring tool, and an outer radius of the uniformly distributed torus heat source is same as a radius of the stirring part of the real stirring tool;
a radius of the uniformly distributed cylinder heat source is same as the radius of the stirring pin of the real stirring tool, and a height of the uniformly distributed cylinder heat source is same as a height of the stirring pin of the real stirring tool.

14. The computer device according to claim 8, wherein the performing a heat transfer simulation on a welding process and a cooling process of friction stir welding by using the system finite element model comprising the heat source model to obtain a temperature field result of a real weldment comprises:
applying a convection boundary condition and a radiation boundary condition in the system finite element model comprising the heat source model;
controlling the heat source model to move along the welding seam position at a predetermined moving speed, so as to simulate the welding process of the friction stir welding, and simultaneously performing heat transfer analysis to obtain the temperature field of the real weldment at each moment in the welding process; and
stopping applying the heat source model after completing welding to simulate the cooling process of the friction stir welding, and simultaneously performing heat transfer analysis to obtain the temperature field of the real weldment at each moment in the cooling process.

15. The computer device according to claim 8, wherein the performing a thermal-mechanical simulation on the welding process, the cooling process and a clamp release process of the friction stir welding with synchronous rolling by using the system finite element model comprising the contact relationships and the mechanical action relationships, with the temperature field result as an input, so as to obtain a welding stress result and a welding deformation result of the real weldment, comprises:
applying a clamp constraint and a backing plate constraint in the system finite element model comprising the contact relationships and the mechanical action relationships, wherein the clamp is configured to fix the weldment finite element model, and the backing plate is configured to support the weldment finite element model;
controlling the roller finite element model and the stirring tool finite element model to move along the welding seam position at a predetermined moving speed, so as to simulate the welding process of the friction stir welding with synchronous rolling, and simultaneously performing thermal-mechanical analysis with the temperature field of the real weldment at each moment in the welding process as an input, so as to obtain the welding stress field and the welding deformation field of the real weldment at each moment in the welding process;
controlling the roller finite element model and the stirring tool finite element model simultaneously to stop moving after completing welding, so as to simulate the cooling process of the friction stir welding with synchronous rolling, and simultaneously performing thermal-mechanical analysis with the temperature field of the real weldment at each moment in the cooling process as an input, so as to obtain the welding stress field and the welding deformation field of the real weldment at each moment in the cooling process; and
removing the clamp after completing cooling, so as to simulate the clamp release process of the friction stir welding with synchronous rolling, and simultaneously performing elastic-plastic mechanical analysis, so as to obtain the welding stress field and the welding deformation field of the real weldment at each moment in the clamp release process.

16. The non-transitory computer-readable storage medium according to claim 9, wherein the establishing a system finite element model of the friction stir welding with synchronous rolling comprises:
establishing a system geometric structure model of the friction stir welding with synchronous rolling; wherein the system geometric structure model comprises a roller geometric structure model, a stirring tool geometric structure model and a weldment geometric structure model, the roller geometric structure model and the stirring tool geometric structure model are arranged perpendicularly to the weldment geometric structure model, the roller geometric structure model and the stirring tool geometric structure model are in contact with an upper surface of a welding seam position of the weldment geometric structure model, and the roller geometric structure model and the stirring tool geometric structure model are arranged at intervals; a structure and a size of the roller geometric structure model are same as those of the real roller; a structure of the stirring tool geometric structure model is a cylinder, a diameter of the stirring tool geometric structure model is same as that of a stirring part of the real stirring tool; and a structure and a size of the weldment geometric structure model are same as those of the real weldment;
setting the roller geometric structure model as a rigid body model to obtain the roller finite element model;
setting the stirring tool geometric structure model as a rigid body model to obtain the stirring tool finite element model;
setting the weldment geometric structure model as a flexible body model, setting a material property of the weldment geometric structure model, and meshing the weldment geometric structure model, so as to obtain the weldment finite element model; and
forming the system finite element model of the friction stir welding with synchronous rolling by the roller finite element model, the stirring tool finite element model and the weldment finite element model.

17. The non-transitory computer-readable storage medium according to claim 16, wherein the meshing the weldment geometric structure model comprises:
dividing the weldment geometric structure model into a first area and a second area, wherein the first area refers to an area with the welding seam position as a center line, having a length identical to that of the weldment geometric structure model and a width of a predetermined value, and the second area refers to other areas in the weldment geometric structure model except the first area; and
meshing the first area according to a principle of equal mesh size, and meshing the second area according to a principle that a size of a mesh increases as a distance of the mesh from the welding seam position increases; wherein a size of a smallest mesh obtained by meshing the second area is larger than a size of a mesh obtained by meshing the first area.

18. The non-transitory computer-readable storage medium according to claim 9, wherein the heat source model is a composite heat source comprising a uniformly distributed torus heat source and a uniformly distributed cylinder heat source, an axis of the uniformly distributed torus heat source is coaxial with an axis of the uniformly distributed cylinder heat source, the uniformly distributed torus heat source is coplanar with an upper surface of the uniformly distributed cylinder heat source, and the upper surface of the uniformly distributed cylinder heat source is a circular surface;
an inner radius of the uniformly distributed torus heat source is same as a radius of a stirring pin of the real stirring tool, and an outer radius of the uniformly distributed torus heat source is same as a radius of the stirring part of the real stirring tool;
a radius of the uniformly distributed cylinder heat source is same as the radius of the stirring pin of the real stirring tool, and a height of the uniformly distributed cylinder heat source is same as a height of the stirring pin of the real stirring tool.

19. The non-transitory computer-readable storage medium according to claim 9, wherein the performing a heat transfer simulation on a welding process and a cooling process of friction stir welding by using the system finite element model comprising the heat source model to obtain a temperature field result of a real weldment comprises:
applying a convection boundary condition and a radiation boundary condition in the system finite element model comprising the heat source model;
controlling the heat source model to move along the welding seam position at a predetermined moving speed, so as to simulate the welding process of the friction stir welding, and simultaneously performing heat transfer analysis to obtain the temperature field of the real weldment at each moment in the welding process; and
stopping applying the heat source model after completing welding to simulate the cooling process of the friction stir welding, and simultaneously performing heat transfer analysis to obtain the temperature field of the real weldment at each moment in the cooling process.

20. The non-transitory computer-readable storage medium according to claim 9, wherein the performing a thermal-mechanical simulation on the welding process, the cooling process and a clamp release process of the friction stir welding with synchronous rolling by using the system finite element model comprising the contact relationships and the mechanical action relationships, with the temperature field result as an input, so as to obtain a welding stress result and a welding deformation result of the real weldment, comprises:
applying a clamp constraint and a backing plate constraint in the system finite element model comprising the contact relationships and the mechanical action relationships, wherein the clamp is configured to fix the weldment finite element model, and the backing plate is configured to support the weldment finite element model;
controlling the roller finite element model and the stirring tool finite element model to move along the welding seam position at a predetermined moving speed, so as to simulate the welding process of the friction stir welding with synchronous rolling, and simultaneously performing thermal-mechanical analysis with the temperature field of the real weldment at each moment in the welding process as an input, so as to obtain the welding stress field and the welding deformation field of the real weldment at each moment in the welding process;
controlling the roller finite element model and the stirring tool finite element model simultaneously to stop moving after completing welding, so as to simulate the cooling process of the friction stir welding with synchronous rolling, and simultaneously performing thermal-mechanical analysis with the temperature field of the real weldment at each moment in the cooling process as an input, so as to obtain the welding stress field and the welding deformation field of the real weldment at each moment in the cooling process; and
removing the clamp after completing cooling, so as to simulate the clamp release process of the friction stir welding with synchronous rolling, and simultaneously performing elastic-plastic mechanical analysis, so as to obtain the welding stress field and the welding deformation field of the real weldment at each moment in the clamp release process.
